(19) United States
(12) Patent Application Publication
(10) Pub. No.: US 2025/0309574 A1
(43) Pub. Date: Oct. 2, 2025

(54) CONNECTOR AND ELECTRONIC DEVICE

(71) Applicant: KYOCERA CORPORATION, Kyoto (JP)

(72) Inventor: Hengfeng LU, Sagamihara-shi, Kanagawa (JP)

(21) Appl. No.: 18/855,624

(22) PCT Filed: Apr. 6, 2023
(86) PCT No.: PCT/JP2023/014280

§ 371 Date: Oct. 9, 2024

(30) Foreign Application Priority Data
Apr. 13, 2022 (JP) 2022-066423

(51) Int. Cl. H01R 12/77; H01R 12/79; H01R 12/88

(52) U.S. Cl. CPC H01R 12/774; H01R 12/79; H01R 12/88

(57) ABSTRACT

In the present disclosure, a connector 10 includes: an insulator 20 including an insertion portion 23 into which a connection object 70 is inserted; multiple contacts 30; and a lock member 60, and the lock member 60 includes: an elastically deformable hold portion 61 extending in an insertion-pull-out direction of the connection object 70; a support receiving portion 63 adjoining the hold portion 61 in a direction different from the insertion-pull-out direction; an elastically deformable first connection portion 62 located on an insertion side on which the connection object 70 is inserted relative to the hold portion 61 and the support receiving portion 63 and connecting the hold portion 61 and the support receiving portion 63; a lock portion 64 located in the hold portion 61 and configured to be engaged with a lock receiving portion 77 of the connection object 70 in an inserted state in which the connection object 70 is inserted into the insertion portion 23; and an attachment portion 68 located in the support receiving portion 63 and configured to be attached to the insulator 20 or a circuit board CB.

### CROSS-REFERENCE TO RELATED APPLICATIONS

The present application claims priority from Japanese Patent Application No. 2022-066423 (filed Apr. 13, 2022) the disclosure of which is hereby incorporated by reference herein in its entirety.

### TECHNICAL FIELD

The present disclosure relates to a connector and an electronic device.

### BACKGROUND OF INVENTION

A technique related to a connector used in communication devices and the like and configured to be connected to a connection object such as a flexible printed circuit board (FPC), a flexible flat cable (FFC), or the like is known.

For example, Patent Literature 1 discloses a connector in which a rear end portion of an upper arm of a lock member is pushed upward to be away from a rear end portion of a lower arm, a front end portion of the lower arm comes close to a front end portion of the upper arm, and a lock protrusion is moved toward an upper plate portion in a connection-object receiving portion and locks the connection object at the position of a connection end portion. The connector as mentioned above can effectively avoid coming-out of a plate-shaped or sheet-shaped connection object in a mated state.

### CITATION LIST

### Patent Literature

Patent Literature 1: Japanese Patent No. 6342300

### SUMMARY

A connector according to an embodiment of the present disclosure is
a connector that a connection object is inserted into and pulled out from, including:
an insulator including an insertion portion into which the connection object is inserted;
multiple contacts attached to the insulator; and
a lock member attached to the insulator.

The lock member includes:
an elastically deformable hold portion extending in an insertion-pull-out direction of the connection object;
a support receiving portion adjoining the hold portion in a direction different from the insertion-pull-out direction;
an elastically deformable first connection portion located on an insertion side on which the connection object is inserted relative to the hold portion and the support receiving portion and connecting the hold portion and the support receiving portion;
a lock portion located in the hold portion and configured to be engaged with a lock receiving portion of the connection object in an inserted state in which the connection object is inserted into the insertion portion; and
an attachment portion located in the support receiving portion and configured to be attached to the insulator or a circuit board.

In an embodiment of the present disclosure, an electronic device includes the connector described above.

### BRIEF DESCRIPTION OF THE DRAWINGS

FIG. 1 is a perspective view of a connector according to an embodiment and a connection object in a non-inserted state, illustrating the outer appearance from above.

FIG. 2 is a perspective view of the connector and the connection object in FIG. 1, illustrating the outer appearance from below.

FIG. 3 is an exploded perspective view of the connector in FIG. 1.

FIG. 4 is a perspective view of a lock member in FIG. 3 alone, illustrating the outer appearance from above.

FIG. 5 is an enlarged front view of a dashed-dotted-line rectangular portion V in FIG. 1, from the front.

FIG. 6 is a first perspective view of the connector according to an embodiment and the connection object in an inserted state, illustrating the outer appearance from above.

FIG. 7 is a second perspective view of the connector according to an embodiment and the connection object in the inserted state, illustrating the outer appearance from above.

FIG. 8 is a third perspective view of the connector according to an embodiment and the connection object in the inserted state, illustrating the outer appearance from above.

FIG. 9 is an enlarged top view of the dashed-dotted-line rectangular portion IX in FIG. 6.

FIG. 10 is a cross-sectional view taken along arrow line X-X in FIG. 9.

FIG. 11 is a cross-sectional view taken along arrow line XI-XI in FIG. 9.

FIG. 12 is a cross-sectional view taken along arrow line XII-XII in FIG. 9 without illustration of the connection object.

FIG. 13 is a cross-sectional view corresponding to FIG. 12 with an actuator at a half-open position.

FIG. 14 is a cross-sectional view corresponding to FIG. 12 with the actuator at an open position.

FIG. 15 is a cross-sectional view corresponding to FIG. 12 with the connection object illustrated.

FIG. 16 is a cross-sectional view corresponding to FIG. 13 with the connection object illustrated.

FIG. 17 is a cross-sectional view corresponding to FIG. 14 with the connection object illustrated.

### DESCRIPTION OF EMBODIMENTS

Along with downsizing of communication devices and the like in recent years, reduction in footprint and height is required also for the connectors connected to connection objects. However, when trying to achieve reduction in the footprint of a connector, there is a problem that designing a structure for the connector to lock the connection object is difficult.

For example, in a case of a lock member included in the connector disclosed in Patent Literature 1, when the dimension of the connector in the insertion-pull-out direction of the connection object is reduced, keeping the spring of the lock member long is difficult. When the spring of the lock member is reduced, for example, the lock member is less likely to be deformed elastically, causing a problem that the lock member is more likely to be deformed plastically. This decreases the reliability of the connector as a product.

In an embodiment of the present disclosure, the connector and the electronic device can maintain reliability even if they are downsized.

Hereinafter, an embodiment of the present disclosure will be described in detail with reference to the accompanying drawings. In the following description, the front-rear direction, the right-left direction, and the up-down direction are based on the arrow directions in the figures. The direction of each arrow is consistent across the different drawings. In some drawings, illustration of a circuit board CB described later is omitted to make illustration simple.

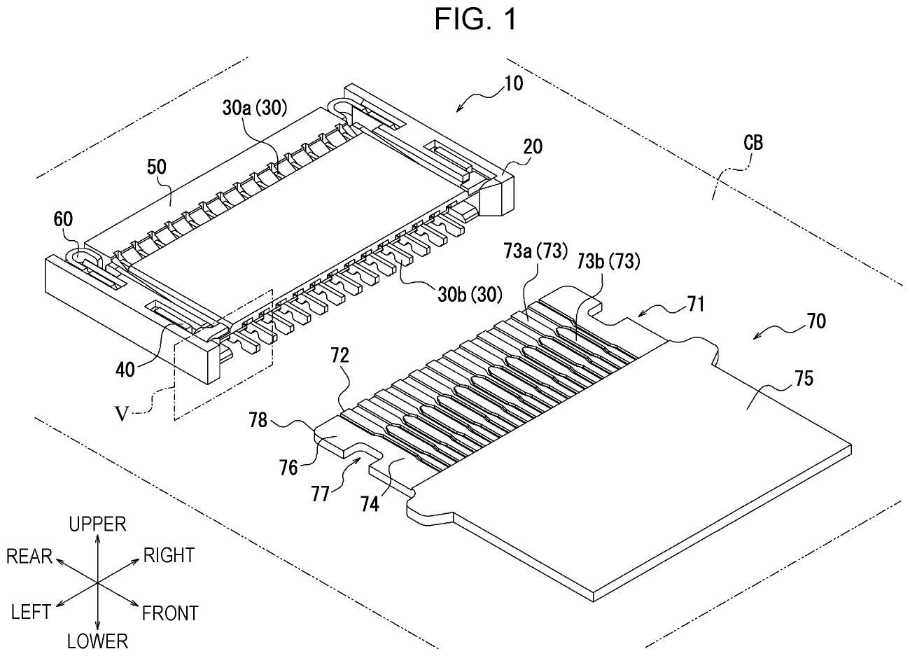

The configuration of a connector 10 according to an embodiment and the configuration of a connection object 70 are mainly described with reference to FIGS. 1 to 9.

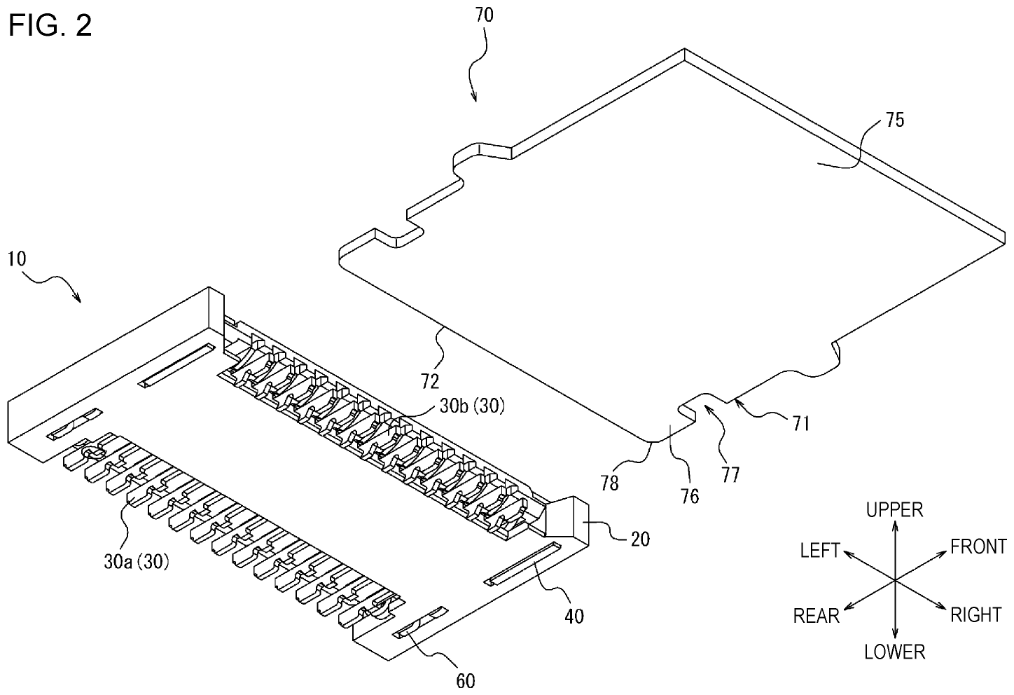

FIG. 1 is a perspective view of the connector 10 according to an embodiment and the connection object 70 in a non-inserted state, illustrating the outer appearance from above. FIG. 2 is a perspective view of the connector 10 and the connection object 70 in FIG. 1, illustrating the outer appearance from below.

As illustrated in FIGS. 1 and 2, the connector 10 includes an insulator 20, contacts 30 including first contacts 30a and second contacts 30b, metal members 40, an actuator 50, and lock members 60. The first contacts 30a, the second contacts 30b, the metal members 40, the actuator 50, and the lock members 60 are attached to the insulator 20.

In this specification, “the non-inserted state” denotes, for example, a state in which the connection object 70 is not inserted into the connector 10, which includes a state in which the first contacts 30a and the second contacts 30b of the connector 10 are not elastically deformed. An “inserted state” denotes, for example, a state in which the connection object 70 is inserted into the connector 10, which includes a state in which the first contacts 30a and the second contacts 30b are in contact with the connection object 70 and are elastically deformed.

In this specification, a “closed position” includes, for example, a position of the actuator 50 at which the actuator 50 is closed relative to the insulator 20. When the connector 10 and the connection object 70 are in the inserted state, and the actuator 50 is at the closed position, the connector 10 holds the connection object 70. An “open position” includes, for example, a position of the actuator 50 at which the actuator 50 is open, being inclined at a specified angle relative to the insulator 20. When the actuator 50 is at the open position, the connection object 70 inserted into the connector 10 can be pulled out from the connector 10. A “half-open position” includes a position of the actuator 50 at which the actuator 50 is between the closed position and the open position. The actuator 50 can be turned relative to the insulator 20 between the open position and the closed position via the half-open position.

In this specification, a “closed state” includes, for example, a state of the connector 10 in which the actuator 50 is at the closed position. A “half-open state” includes, for example, a state of the connector 10 in which the actuator 50 is at a half-open position. An “open state” includes, for example, a state of the connector 10 in which the actuator 50 is at the open position.

“An insertion-pull-out direction of the connection object 70” used below refers to the front-rear direction as an example. “The insertion direction of the connection object 70” refers to the rearward direction as an example. “The pull-out direction of the connection object 70” refers to the frontward direction as an example. “An arrangement direction of the multiple contacts 30” refers to the right-left direction as an example. “A direction orthogonal to the insertion-pull-out direction of the connection object 70 and the arrangement direction of the multiple contacts 30” refers to the up-down direction as an example. A “pull-out side” refers to the front side as an example. An “insertion side” refers to the rear side as an example. An “insertion opening 23a side” refers to the front side as an example. An “open-position side” refers to the upper side as an example. A “closed-position side” refers to the lower side as an example. A “circuit board CB side” refers to the lower side as an example. “The side opposite to the circuit board CB” refers to the upper side as an example.

As illustrated in FIG. 1, the connector 10 according to an embodiment is mounted on a circuit board CB. The circuit board CB may be a rigid board or may be any other circuit board. The connector 10 electrically connects the connection object 70 inserted into the connector 10 to the circuit board CB with the first contacts 30a and the second contacts 30b interposed therebetween. The connection object 70 can be inserted into and pulled out from the connector 10, and the connector 10 is connected to the connection object 70 in the inserted state.

The following description is based on the assumption that the connection object 70 is inserted into the connector 10 parallel to the circuit board CB on which the connector 10 is mounted. The connection object 70 is inserted into the connector 10 in the front-rear direction as an example. However, the present disclosure is not limited to this configuration. The connection object 70 may be inserted into the connector 10 in the direction orthogonal to the circuit board CB on which the connector 10 is mounted. The connection object 70 may be inserted into the connector 10 in the up-down direction.

The connection object 70 is a flexible printed circuit board (FPC) as an example. However, the present disclosure is not limited to this configuration. The connection object 70 may be any cable that is electrically connected to the circuit board CB with the connector 10 interposed therebetween. For example, the connection object 70 may be a flexible flat cable (FFC). The connection object 70 is not limited to the cables as mentioned above and may be any connection object. Examples of the connection object 70 may include a rigid board or any other circuit board.

As illustrated in FIGS. 1 and 2, the connection object 70 includes a distal end portion 71 located on the insertion side of the connection object 70 and configured to be stored in the connector 10 in the inserted state. The connection object 70 includes a distal end surface 72 which is the end surface of the distal end portion 71 on the insertion side of the connection object 70. The connection object 70 includes multiple signal lines 73 extending linearly in the insertion-pull-out direction of the connector 10 to the distal end portion 71. The signal lines 73 include first signal lines 73a and second signal lines 73b alternately arranged in the right-left direction. The first signal lines 73a extend to the distal end surface 72 in the distal end portion 71. The second signal lines 73b do not extend to the distal end surface 72 in the distal end portion 71 and stop at a center portion of the distal end portion 71 in the front-rear direction.

The connection object 70 includes ground portions 74 formed in end portions of the distal end portion 71 in the right-left direction so as to be located on both sides of the signal lines 73 in the right-left direction. The connection object 70 includes an outer cover 75 covering the signal lines 73 and the ground portions 74 on the pull-out side of the connection object 70. The signal lines 73 and the ground portions 74 are covered with the outer cover 75 on the pull-out side of the connection object 70 and exposed on the upper side in the distal end portion 71.

The connection object 70 includes hold portions 76 formed on both right and left side portions of the insertion side of the distal end portion 71. The connection object 70 includes lock receiving portions 77 adjoining the pull-out sides of the hold portions 76 and formed in such a shape that both right and left side edge portions of the distal end portion 71 are cut out. The connection object 70 includes introduction portions 78 located at corner portions of the insertion sides of the hold portions 76 and having rounded shapes.

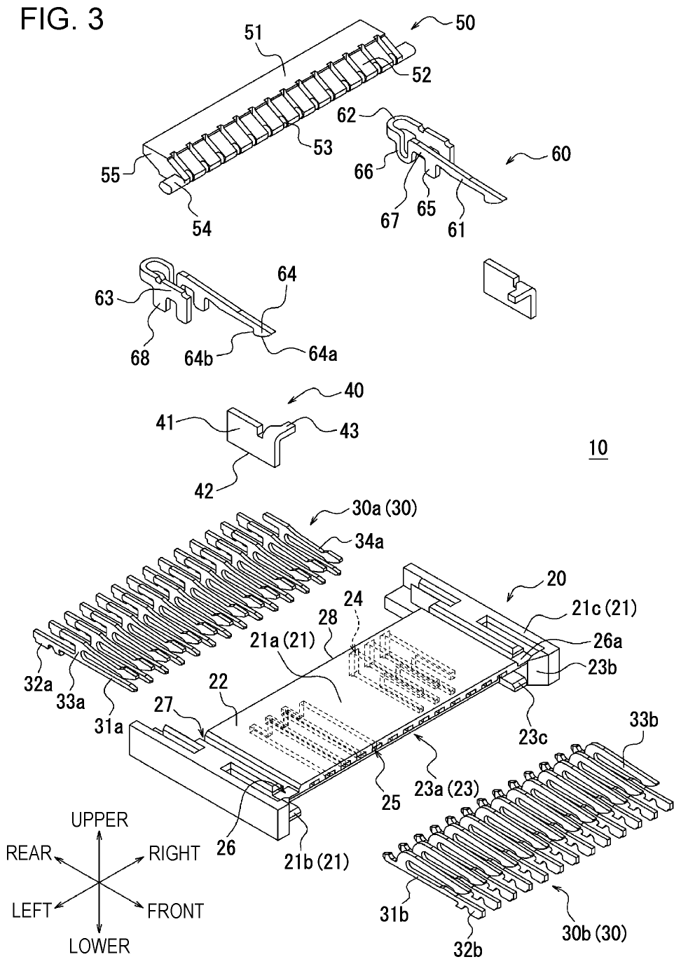

FIG. 3 is an exploded perspective view of the connector 10 in FIG. 1.

As illustrated in FIG. 3, the connector 10 is assembled by the following method as an example. From the rear side of the insulator 20, the first contacts 30a are press-fitted into the insulator 20. From the front side of the insulator 20, the second contacts 30b are press-fitted into the insulator 20. From above the insulator 20, the metal members 40 are press-fitted into the insulator 20. The actuator 50 is placed on the insulator 20 from the rear side so as to be at the closed position and is supported from below by the first contacts 30a press-fitted into the insulator 20. With this, the actuator 50 is attached to the insulator 20 on the insertion side. With the actuator 50 attached to the insulator 20, the lock members 60 are attached to the inside of the insulator 20 from above the insulator 20.

The configuration of the insulator 20 will be mainly described with reference to FIG. 3.

The insulator 20 is a box-shaped member symmetrical in the right-left direction, formed by injection-molding an insulating and heat-resistant plastic material. However, the present disclosure is not limited to this configuration. The insulator 20 may be formed to be asymmetrical in the right-left direction. The insulator 20 includes four outer walls on the upper, lower, right, and left sides and includes an outer peripheral wall 21 formed in a recessed shape as a whole when viewed from above. The outer peripheral wall 21 includes a ceiling wall 21a, a bottom wall 21b, and a pair of side walls 21c. The pair of side walls 21c extend longer on the insertion side than the ceiling wall 21a and the bottom wall 21b. The insulator 20 includes a rear wall 22 connecting the ceiling wall 21a and the bottom wall 21b of the insulator 20 at a rear end portion in the up-down direction.

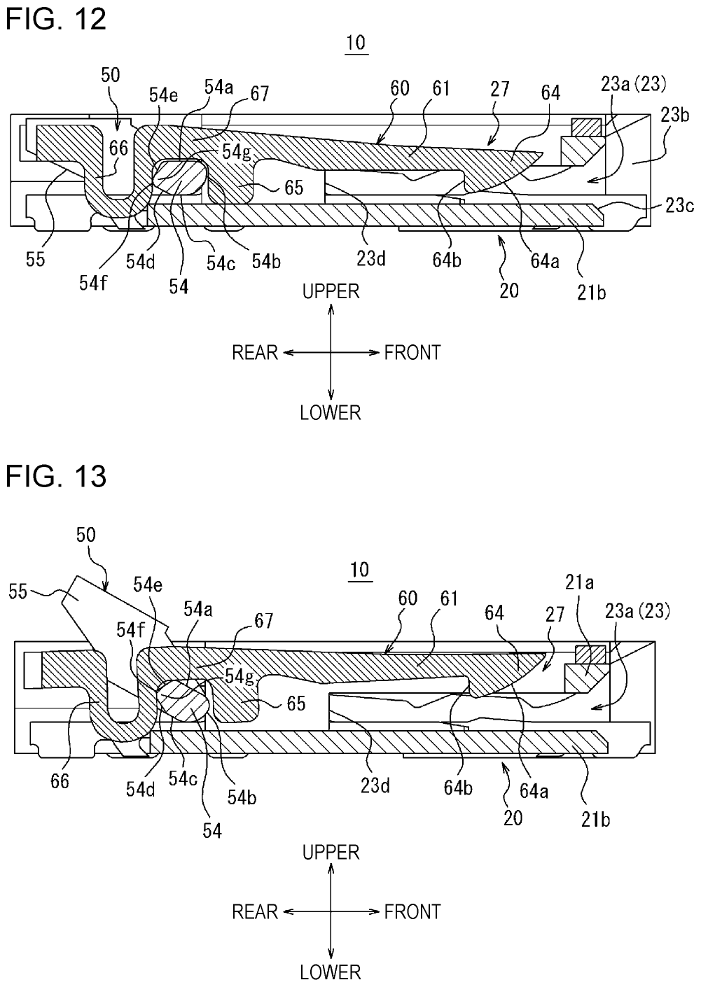

The insulator 20 includes an insertion portion 23 surrounded by the ceiling wall 21a, the bottom wall 21b, the pair of side walls 21c, and the rear wall 22. The insulator 20 includes an insertion opening 23a of the insertion portion 23 which is an opening at the front end portion. The insulator 20 includes first inclined surfaces 23b located in front end portions of the side walls 21c and inclined inward in the right-left direction from the outer side to the inner side in the front-rear direction and connected to the insertion portion 23. The insulator 20 includes second inclined surfaces 23c formed in front end portions of the insertion portion 23 and inclined inward in the up-down direction from the outer side to the inner side in the front-rear direction. For example, as illustrated in FIG. 12 described later, the insertion portion 23 includes an inner surface 23d that serves as a reference for positioning the distal end surface 72 of the connection object 70 in the insertion direction in the inserted state.

The insulator 20 includes first-contact attachment slits 24 extending through the rear wall 22 and formed so as to extend inside the insertion portion 23. The insulator 20 includes second-contact attachment slits 25 formed so as to extend in the entire length of the ceiling wall 21a and the bottom wall 21b in the front-rear direction. The second-contact attachment slits 25 include recesses formed on the inner side of the ceiling wall 21a in the up-down direction. The second-contact attachment slits 25 include recesses formed on the inner side of the bottom wall 21b in the up-down direction.

The multiple first-contact attachment slits 24 are spaced at specified intervals in the right-left direction. The multiple second-contact attachment slits 25 are spaced at specified intervals in the right-left direction. The distance in the right-left direction between each pair of adjacent ones of the second-contact attachment slits 25 is approximately the same as the distance in the right-left direction between each pair of adjacent ones of the first-contact attachment slits 24. The first-contact attachment slits 24 and the second-contact attachment slits 25 are alternately located in the arrangement direction of the multiple contacts 30.

The insulator 20 includes metal-member attachment slits 26 which are recesses in front half portions of the side walls 21c. The metal-member attachment slit 26 includes a wall portion 26a located at a front-side corner portion of the insulator 20 and extending over the side wall 21c and the ceiling wall 21a. The insulator 20 includes attachment slits 27 which are recesses extending from rear half portions of the side walls 21c to positions on the ceiling wall 21a adjacent to the metal-member attachment slits 26. The insulator 20 includes a restriction surface 28 which is a rear surface of the rear wall 22.

The configuration of the first contact 30a will be mainly described with reference to FIG. 3.

The first contact 30a is formed, for example, by forming a thin plate composed of a copper alloy having a spring elasticity such as phosphor bronze, beryllium copper, or titanium copper, or a Corson copper alloy into the shape illustrated in FIG. 3 by using a progressive die (stamping). The first contact 30a is formed, for example, by only punching processes. The forming method of the first contact 30a is not limited to this one and may include, for example, a bending process in the thickness direction after punching processes. The surface of the first contact 30a is undercoated with nickel plating and then surface-plated with gold, tin, or the like. The multiple first contacts 30a are spaced at specified intervals in the right-left direction, corresponding to the multiple first-contact attachment slits 24.

The first contact 30a includes an engagement portion 3 la extending in the insertion-pull-out direction of the connection object 70. The first contact 30a includes a mount portion 32a formed at a rear end portion of the engagement portion 31a. The first contact 30a includes a connection portion 33a extending upward from a center portion of the engagement portion 31a. The first contact 30a includes an elastic contact portion 34a connected to an upper end portion of the connection portion 33a. The elastic contact portion 34a extends in the insertion-pull-out direction of the connection object 70 and is elastically deformable in the up-down direction.

The configuration of the second contact 30b will be mainly described with reference to FIG. 3.

The second contact 30b is formed, for example, by forming a thin plate composed of a copper alloy having a spring elasticity such as phosphor bronze, beryllium copper, or titanium copper, or a Corson copper alloy into the shape illustrated in FIG. 3 by using a progressive die (stamping). The second contact 30b is formed, for example, by only punching processes. The forming method of the second contact 30b is not limited to this one and may include, for example, a bending process in the thickness direction after punching processes. The surface of the second contact 30b is undercoated with nickel plating and then surface-plated with gold, tin, or the like. The multiple second contacts 30b are spaced at specified intervals in the right-left direction, corresponding to the multiple second-contact attachment slits 25.

The second contact 30b includes an engagement portion 31b extending in the insertion-pull-out direction of the connection object 70. The second contact 30b includes a mount portion 32b formed at a front end portion of the engagement portion 31b. The second contact 30b includes an elastic contact portion 33b extending upward from a rear end portion of the engagement portion 31b and then curved in the insertion-pull-out direction of the connection object 70. The elastic contact portion 33b extends in the insertion-pull-out direction of the connection object 70 and is elastically deformable in the up-down direction.

The configuration of the metal member 40 will be mainly described with reference to FIG. 3.

The metal member 40 is formed by forming a thin plate composed of any metal material into the shape illustrated in FIG. 3 by using a progressive die (stamping). The metal member 40 is formed by, for example, a process of punching and then bending in the thickness direction. The forming method of the metal member 40 is not limited to this one and may include, for example, only punching processes. The pair of metal members 40 are located at both right and left ends of the connector 10.

The metal member 40 includes a base portion 41. The base portion 41 has a rectangular shape extending in the front-rear and up-down directions. The metal member 40 includes a mount portion 42 which is a lower end portion of the base portion 41. The mount portion 42 is located across the entire base portion 41 in the front-rear direction. The metal member 40 includes a ceiling portion 43 located at a front end portion of the base portion 41 and curved and extending inward in the right-left direction.

The configuration of the actuator 50 will be described mainly with reference to FIG. 3.

The actuator 50 is a plate-shaped member symmetrical in the right-left direction and extending in the right-left direction as illustrated in FIG. 3, formed by injection-molding an insulating and heat-resistant plastic material. However, the present disclosure is not limited to this configuration. The actuator 50 may be formed to be asymmetrical in the right-left direction. The actuator 50 includes a plate-shaped base portion 51 extending in the right-left direction. The actuator 50 includes a restriction receiving surface 52 which is a front surface of the base portion 51. The restriction receiving surface 52 is an inclined surface inclined obliquely upward from front toward rear when the actuator 50 is at the closed position.

The actuator 50 includes cam portions 53 located at front end portions of cut-in portions having such a shape that the restriction receiving surface 52 is cut in in the front-rear direction. The multiple cam portions 53 are spaced at specified intervals in the right-left direction. The actuator 50 includes a pair of press portions 54 protruding outward in the right-left direction from the side surfaces of the actuator 50 in the right-left direction and located at positions on both sides of the multiple cam portions 53 in the right-left direction.

The press portion 54, as illustrated in FIG. 12 described later, includes a first surface 54a which is level when the actuator 50 is at the closed position. The press portion 54 includes a second surface 54b which is a curved surface connected to the first surface 54a and facing forward. The press portion 54 includes a third surface 54c which is a bottom surface of the press portion 54 and is connected to the second surface 54b. The press portion 54 includes a fourth surface 54d connected to the third surface 54c and extending obliquely upward toward the rear. The press portion 54 includes a fifth surface 54e connected to the first surface 54a and extending obliquely downward toward the rear. The press portion 54 includes a rounded surface 54f connecting the fourth surface 54d and the fifth surface 54e. The press portion 54 includes a pressure contact portion 54g having a rounded shape at a rear portion including the fourth surface 54d, the rounded surface 54f, and the fifth surface 54e.

As illustrated in FIG. 3, the actuator 50 includes an operation portion 55 formed at a rear portion of the base portion 51. The upper surface of the operation portion 55 is level when the actuator 50 is at the closed position, and the lower surface of the operation portion 55 is inclined obliquely upward from front toward rear. Thus, the operation portion 55 is tapered toward the rear.

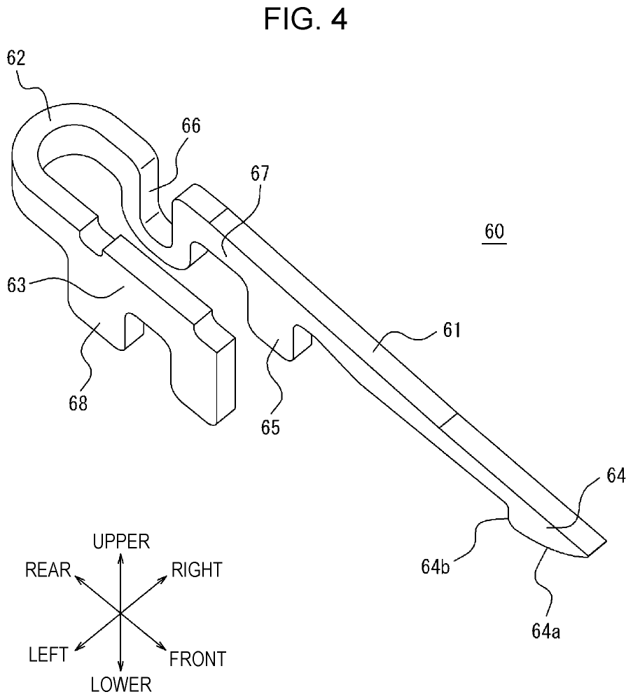

FIG. 4 is a perspective view of a lock member 60 in FIG. 3 alone, illustrating the outer appearance from above. The configuration of the lock member 60 will be mainly described with reference to FIGS. 3 and 4.

The lock member 60 is formed by forming a thin plate composed of any metal material into the shape illustrated in FIG. 4 by using a progressive die (stamping). The lock member 60 is formed into a J shape as a whole by, for example, punching and then bending in the thickness direction. The forming method of the lock member 60 is not limited to this one and may include, for example, only punching processes. The pair of lock members 60 are located at both right and left ends of the connector 10.

The lock member 60 includes an elastically deformable hold portion 61 extending in the insertion-pull-out direction of the connection object 70. The lock member 60 includes an elastically deformable first connection portion 62 extending from the hold portion 61 in a direction different from the insertion-pull-out direction of the connection object 70. The first connection portion 62 as a whole extends in the arrangement direction of the multiple contacts 30. The first connection portion 62 is curved in a U shape. The first connection portion 62 extends outward of the hold portion 61 in the right-left direction while curving from a rear end portion of the hold portion 61 at 180 degrees. The lock member 60 includes a first support receiving portion 63 extending from the first connection portion 62. The first support receiving portion 63 extends in the insertion-pull-out direction of the connection object 70. The first support receiving portion 63 is adjacent to the hold portion 61 in a direction different from the insertion-pull-out direction of the connection object 70, for example, in the arrangement direction of the multiple contacts 30.

The hold portion 61 and the first support receiving portion 63 are connected by the first connection portion 62 curved in a U shape and are parallel to each other along the insertion-pull-out direction of the connection object 70. The first connection portion 62 is located on the insertion side on which the connection object 70 is inserted relative to the hold portion 61 and the first support receiving portion 63 and connects the hold portion 61 and the first support receiving portion 63.

The lock member 60 includes a lock portion 64 formed at a front end portion of the hold portion 61. The lock portion 64 includes a contact surface 64a which is the front face of the lock portion 64 and is a curved surface. The lock portion 64 includes a restriction surface 64b which is a flat surface extending upward from the lower end of the contact surface 64a.

The lock member 60 includes a second support receiving portion 65 protruding downward at a center portion of the hold portion 61. The lock member 60 includes a second connection portion 66 formed at a rear end portion of the hold portion 61. The second connection portion 66 extends toward the circuit board CB in the direction orthogonal to the insertion-pull-out direction of the connection object 70 and the arrangement direction of the multiple contacts 30. The second connection portion 66 is curved in a U shape. The second connection portion 66 connects the first connection portion 62 and the portion of the hold portion 61 located frontward of the second connection portion 66. The lock member 60 includes a press receiving portion 67 formed between the second support receiving portion 65 and the second connection portion 66 in the hold portion 61.

The lock member 60 includes an attachment portion 68 formed in the first support receiving portion 63. The attachment portion 68 has a two-leg shape. The attachment portion 68 is formed at the same position as the press receiving portion 67 in the insertion-pull-out direction of the connection object 70. The press receiving portion 67 and the attachment portion 68 are at the same position in the front-rear direction.

The thickness direction of the hold portion 61 of the lock member 60 is the same as the arrangement direction of the multiple contacts 30. The thickness directions of the hold portion 61 and the first support receiving portion 63 of the lock member 60 are the same as the right-left direction. The rolled surface of the metal plate used for the base material of the lock member 60 in the hold portion 61 and the first support receiving portion 63 is a flat surface extending in the arrangement direction of the multiple contacts 30 and in the up-down direction. The hold portion 61 and the first support receiving portion 63 of the lock member 60 are flat in the insertion-pull-out direction of the connection object 70.

The surface of the lock member 60 is plated, and the plating of the attachment portion 68 has a higher wettability than the plating of the portions other than the attachment portion 68 in the lock member 60. In this specification, “wettability” denotes how easily solder can be in contact with a metal surface when a component is joined with solder. Examples of the plating of the attachment portion 68 include gold plating. Examples of the plating of the portions other than the attachment portion 68 include nickel plating. This reduces solder rising from the attachment portion 68 to the first connection portion 62 and improves the reliability of the connector 10 as a product.

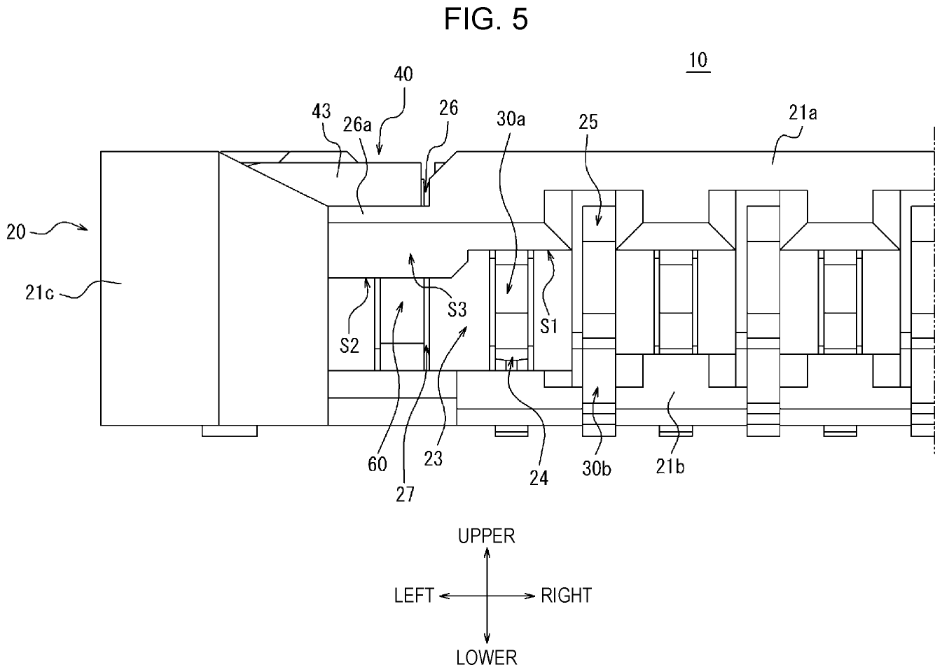

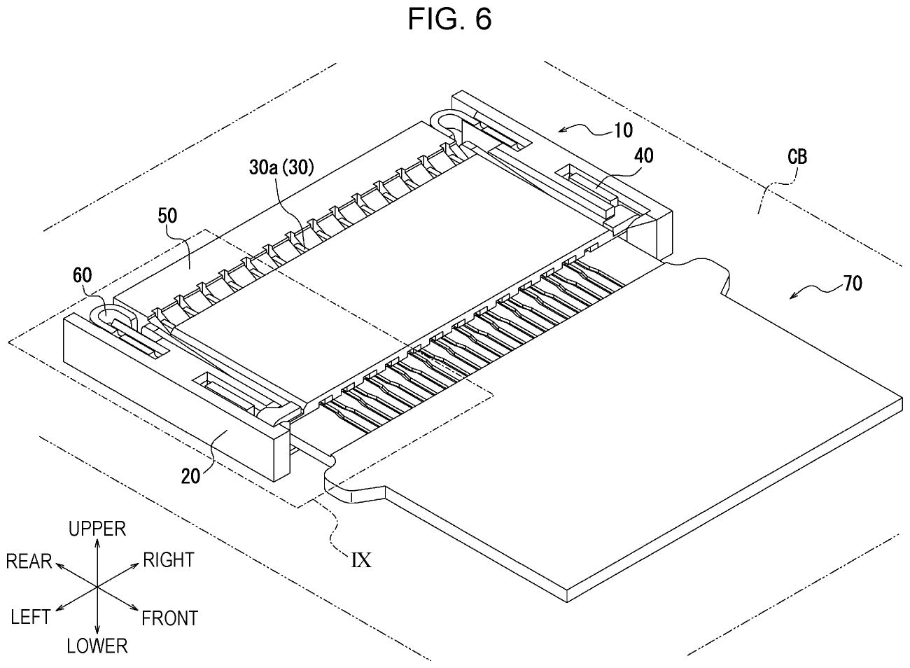

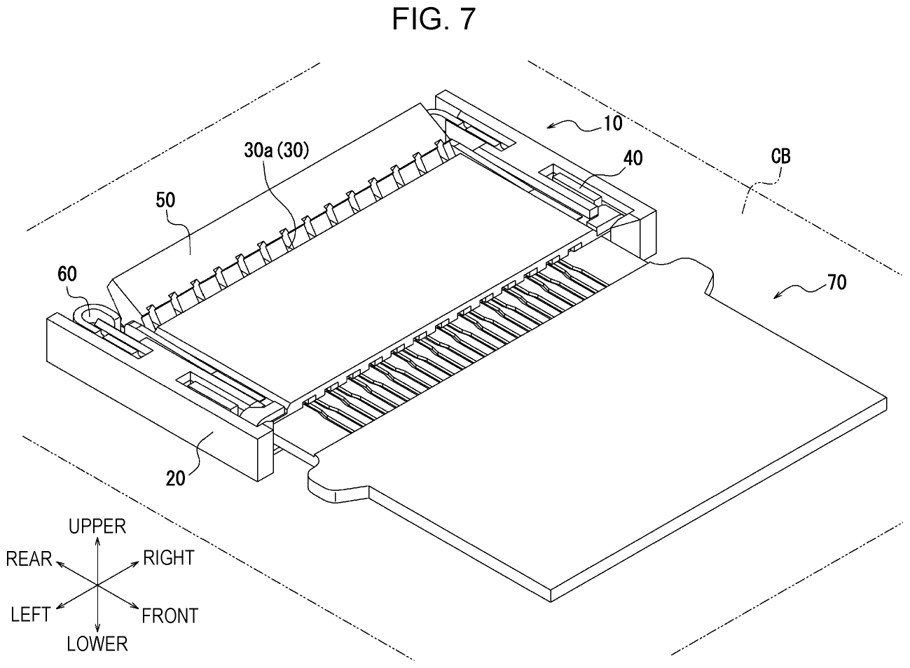

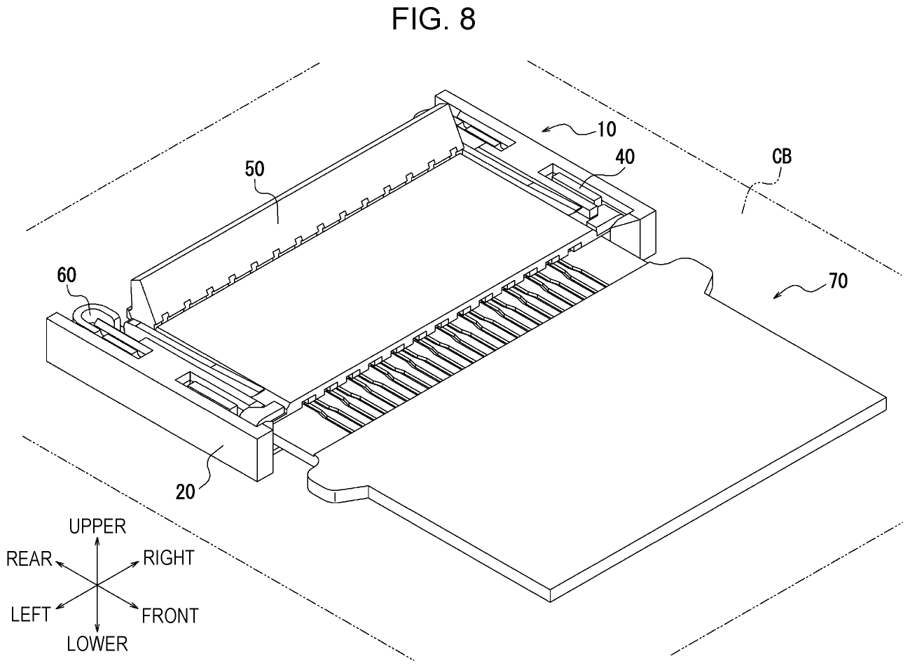

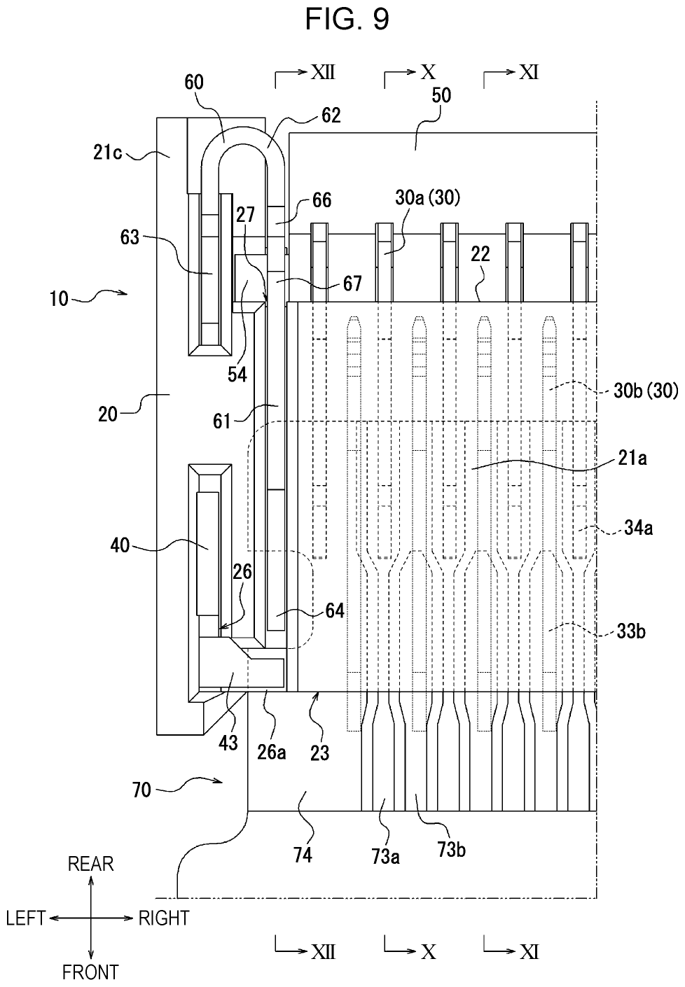

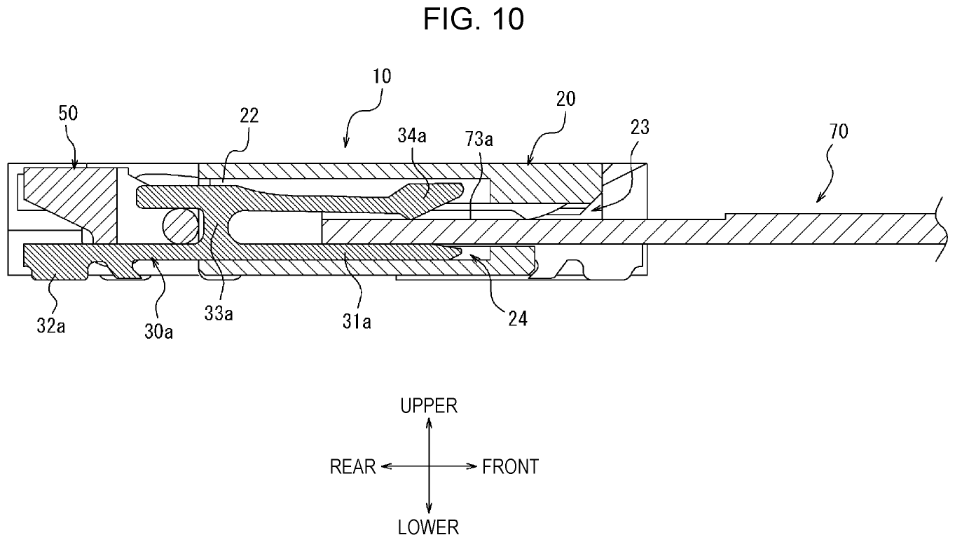

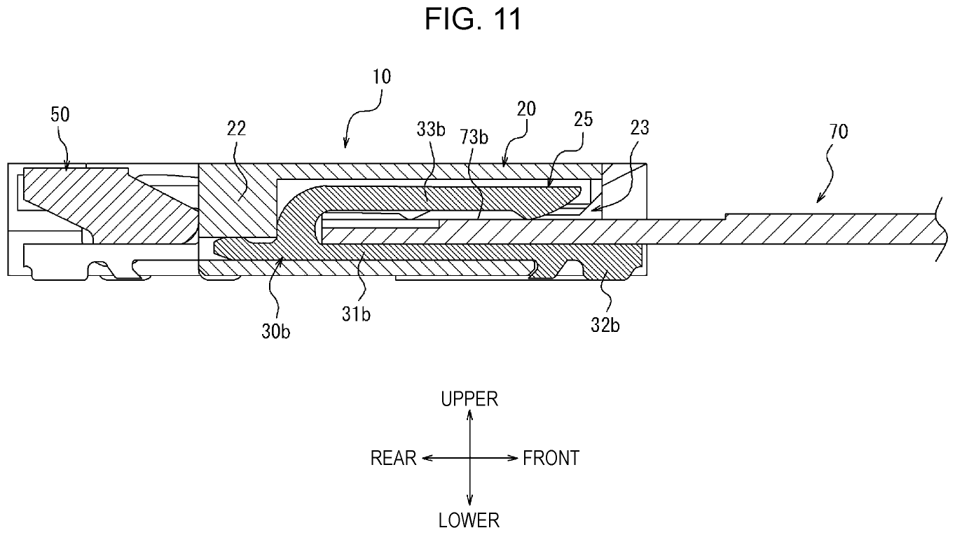

FIG. 5 is an enlarged front view of a dashed-dotted-line rectangular portion V in FIG. 1, from the front. FIG. 6 is a first perspective view of the connector 10 according to an embodiment and the connection object 70 in the inserted state, illustrating the outer appearance from above. In FIG. 6, the actuator 50 of the connector 10 is at the closed position. FIG. 7 is a second perspective view of the connector 10 according to an embodiment and the connection object 70 in the inserted state, illustrating the outer appearance from above. In FIG. 7, the actuator 50 of the connector 10 at a half-open position. FIG. 8 is a third perspective view of the connector 10 according to an embodiment and the connection object 70 in the inserted state, illustrating the outer appearance from above. In FIG. 8, the actuator 50 of the connector 10 is at the open position. FIG. 9 is an enlarged top view of the dashed-dotted-line rectangular portion IX in FIG. 6. FIG. 10 is a cross-sectional view taken along arrow line X-X in FIG. 9. FIG. 11 is a cross-sectional view taken along arrow line XI-XI in FIG. 9.

As illustrated in FIGS. 5 and 9, the metal member 40 is attached to a front half portion of the side wall 21c with the ceiling portion 43 engaged with the metal-member attachment slit 26 of the insulator 20. In this state, the ceiling portion 43 is in contact with or close to the upper surface of the wall portion 26a of the metal-member attachment slit 26 and faces it from above. The ceiling portion 43 is located above the wall portion 26a of the metal-member attachment slit 26. The wall portion 26a is interposed between the ceiling portion 43 of the metal member 40 and the insertion portion 23 of the insulator 20 and separates the ceiling portion 43 and the insertion portion 23. From the inside toward the outside of the insertion portion 23 in the up-down direction, the insertion portion 23 of the insulator 20, the wall portion 26a, and the ceiling portion 43 of the metal member 40 are located in this order.

The metal member 40 is located outward of the outermost first contact 30a in the arrangement direction of the multiple contacts 30. The position of the first-contact attachment slit 24 to which the outermost first contact 30a is attached and the position of the metal-member attachment slit 26 to which the metal member 40 is attached are shifted from each other in the right-left direction in the insulator 20.

The wall portion 26a of the insulator 20 includes a first surface S1 formed so as to overlap the outermost first-contact attachment slit 24 in the right-left direction. The wall portion 26a includes a second surface S2 formed outward of the first surface S1 in the right-left direction and located one step lower than the first surface S1. The second surface S2 is lower than the first surface S1 with the bottom wall 21b of the insulator 20 as a reference. The first surface S1 and the second surface S2 face inward of the insertion portion 23, in other words, downward. The first surface S1 and the second surface S2 are parts of the inner surfaces of the insertion portion 23.

A front surface of the wall portion 26a is refers to as a third surface S3, which extends in the up-down direction and are connected to the first surface S1 to the second surface S2. The third surface S3 is inclined inward in the front-rear direction of the insertion portion 23 from top to bottom. The third surface S3 is an inclined surface inclined rearward and connected to the first surface S1 and the second surface S2. The front end edge portion of the second surface S2 is located rearward of the front end edge portion of the first surface S1.

The metal member 40 is located at the same position as the lock member 60 in the arrangement direction of the multiple contacts 30. The position of the metal-member attachment slit 26 to which the metal member 40 is attached and the position of the attachment slit 27 to which the lock member 60 is attached overlap each other in the front-rear direction in the insulator 20. The metal-member attachment slit 26 and the attachment slit 27 are formed at the same position in the right-left direction in the insulator 20.

As illustrated in FIGS. 3 and 6 to 8, in the connector 10, the actuator 50 is located rearward of the rear wall 22 of the insulator 20 and between the pair of side walls 21c in the right-left direction. The actuator 50 at the closed position is supported from below by the first contacts 30a. In this state, the lower surface of the base portion 51 of the actuator 50 is in contact with the upper surfaces of rear half portions of the engagement portions 31a in the first contacts 30a. The cam portions 53 of the actuator 50 are stored in the regions surrounded by rear half portions of the engagement portions 31a, the connection portions 33a, and rear end portions of the elastic contact portions 34a of the first contacts 30a.

The actuator 50 can be turned relative to the insulator 20 between the closed position at which the actuator 50 is closed relative to the insulator 20 and the open position at which the actuator 50 is open relative to the insulator 20. When the actuator 50 moves from the closed position through the half-open position toward the open position, the actuator 50 is turned from the insertion side to the pull-out side of the connection object 70.

As illustrated in FIGS. 9 and 10, in the connector 10, the first contact 30a is attached to a portion of the insulator 20 from the rear wall 22 to the inside of the insertion portion 23 by the engagement portion 31a being engaged with the first-contact attachment slit 24 of the insulator 20.

In the state in which the engagement portion 31a of the first contact 30a is attached to the first-contact attachment slit 24 of the insulator 20, part of the elastic contact portion 34a is positioned inside the insertion portion 23. In the inserted state in which the connection object 70 is inserted into the insertion portion 23, the elastic contact portions 34a of the pair of outermost first contacts 30a in the right-left direction are in contact with the ground portions 74 of the connection object 70. The elastic contact portions 34a of the other multiple first contacts 30a between the pair of outermost first contacts 30a in the right-left direction are in contact with the first signal lines 73a of the connection object 70.

As illustrated in FIGS. 9 and 11, in the connector 10, the second contact 30b is attached to a portion of the insulator 20 from the inside of the insertion portion 23 to the rear wall 22 by the engagement portion 31b being engaged with the second-contact attachment slit 25 of the insulator 20.

In the state in which the engagement portion 31b of the second contact 30b is attached to the second-contact attachment slit 25 of the insulator 20, part of the elastic contact portion 33b is positioned inside the insertion portion 23. In the inserted state in which the connection object 70 is inserted into the insertion portion 23, the elastic contact portions 33b of the pair of outermost second contacts 30b in the right-left direction are in contact with the ground portions 74 of the connection object 70. The elastic contact portions 33b of the other multiple second contacts 30b between the pair of outermost second contacts 30b in the right-left direction are in contact with the second signal lines 73b of the connection object 70.

As illustrated in FIG. 9, the lock member 60 is attached to the attachment slit 27 of the insulator 20 from the side wall 21c to the ceiling wall 21a. The hold portion 61 of the lock member 60 is located in a portion of the attachment slit 27 located in the ceiling wall 21a. The first support receiving portion 63 of the lock member 60 is located in a portion of the attachment slit 27 located in the side wall 21c. In this state, the hold portion 61 of the lock member 60 is between parts of the insulator 20 in the arrangement direction of the multiple contacts 30. The hold portion 61 is located between the ceiling wall 21a and the side wall 21c so as to be slightly away from the ceiling wall 21a and the side wall 21c in the right-left direction.

The connector 10 is configured to be mounted on a circuit formation surface formed on the upper surface of the circuit board CB located approximately parallel to the insertion-pull-out direction. More specifically, the mount portions 32a of the first contacts 30a are placed on solder paste applied to pads on the circuit board CB. The mount portions 32b of the second contacts 30b are placed on solder paste applied to pads on the circuit board CB. The mount portions 42 of the metal members 40 are placed on solder paste applied to pads on the circuit board CB. The attachment portions 68 of the lock members 60 are placed on solder paste applied to pads on the circuit board CB.

The solder paste is heated and melted in a reflow oven or the like, so that the mount portions 32a, the mount portions 32b, the mount portions 42, and the attachment portions 68 are soldered to the pads mentioned above. With this process, mounting the connector 10 onto the circuit board CB is completed. In this process, the attachment portions 68 of the lock members 60 are attached to the circuit board CB. Thus, the attachment portions 68 of the lock members 60 are mounted onto the circuit board CB. In addition to the connector 10, for example, other electronic components such as a central processing unit (CPU), a controller, and memory are mounted onto the circuit formation surface of the circuit board CB.

FIG. 12 is a cross-sectional view taken along arrow line XII-XII in FIG. 9 without illustration of the connection object 70. The functions of the actuator 50 and the lock member 60 in the state in which the lock members 60 are attached to the circuit board CB with the lock members 60 attached to the attachment slits 27 of the insulator 20, and when the actuator 50 is at the closed position will be mainly described.

The press portion 54 of the actuator 50 is stored in the space formed by the second support receiving portion 65, the press receiving portion 67, and a front portion of the second connection portion 66 of the lock member 60. In this state, the first surface 54a of the press portion 54 faces a lower surface the press receiving portion 67 of the lock member 60 with a gap in between. The second surface 54b of the press portion 54 faces a rear surface of the second support receiving portion 65 of the lock member 60 with a gap in between. The third surface 54c of the press portion 54 faces an upper surface of the bottom wall 21b of the insulator 20 with a gap in between. The pressure contact portion 54g of the press portion 54 composed of the fourth surface 54d, the rounded surface 54f, and the fifth surface 54e and having a rounded shape is in contact with or close to the forefront surface of the second connection portion 66 of the lock member 60.

In this state, the press portion 54 of the actuator 50 does not press the lock member 60. The hold portion 61 of the lock member 60, in the state of not receiving a pressing force from the actuator 50 and not being elastically deformed, extends forward and obliquely downward from a front end portion of the second connection portion 66. Part of the lock portion 64 located at the front end of the hold portion 61 is positioned inside the insertion portion 23 of the insulator 20. The contact surface 64a of the lock portion 64 is located rearward of the insertion opening 23a of the insulator 20. The restriction surface 64b of the lock portion 64 faces the inner surface 23d of the insulator 20 with a specified distance in between.

The second support receiving portion 65 of the lock member 60 is in contact with the upper surface of the bottom wall 21b of the insulator 20. With this, the lock member 60 is supported from below by the bottom wall 21b of the insulator 20. The curved portion of the second connection portion 66 of the lock member 60 is located rearward of the bottom wall 21b of the insulator 20, does not overlap the insulator 20, and is exposed on the lower side through the insulator 20. The distal end of the curved portion in the second connection portion 66 of the lock member 60 is located outward of the inner surface of the insertion portion 23. For example, the lower end portion of the second connection portion 66 of the lock member 60 is located below the upper surface of the bottom wall 21b serving as the inner surface of the insertion portion 23.

The bottom wall 21b of the insulator 20 is interposed between the lock portion 64 of the lock member 60 and the circuit board CB. The insulator 20 is present under the lock portion 64.

FIG. 13 is a cross-sectional view corresponding to FIG. 12 with the actuator 50 at a half-open position.

The functions of the actuator 50 and the lock member 60 in the state in which the lock members 60 are attached to the circuit board CB with the lock members 60 attached to the attachment slits 27 of the insulator 20, and when the actuator 50 is at a half-open position as illustrated in FIG. 13 will be mainly described. The actuator 50 is turned to the pull-out side, for example, when the operation portion 55 receives an operation of lifting the operation portion 55 to the pull-out side from an assembly device or an assembly operator.

The press portion 54 of the actuator 50 is tilted at a first angle along with the turning operation of the actuator 50 in the state in which the press portion 54 of the actuator 50 is stored in the space formed by the second support receiving portion 65, the press receiving portion 67, and the front portion of the second connection portion 66 of the lock member 60. In this state, the first surface 54a of the press portion 54 is inclined obliquely downward from rear toward front and is away from the lock member 60. The second surface 54b of the press portion 54 faces the rear surface of the second support receiving portion 65 of the lock member 60 with a gap in between. The third surface 54c of the press portion 54 is inclined obliquely upward from front toward rear and is away from the lock member 60. The distal end of the pressure contact portion 54g of the press portion 54 composed of the fourth surface 54d, the rounded surface 54f, and the fifth surface 54e and having a rounded shape is in contact with the forefront surface of the second connection portion 66 of the lock member 60. The portion of the pressure contact portion 54g connecting the fifth surface 54e and the first surface 54a is in contact with a lower surface of the press receiving portion 67 of the lock member 60.

The press receiving portion 67 of the lock member 60 receives a pressing force from the press portion 54 at a half-open position of the actuator 50. The hold portion 61, receiving the pressing force from the pressure contact portion 54g due to the contact between the lower surface of the press receiving portion 67 and the pressure contact portion 54g, is elastically deformed slightly upward. At the half-open position, the press portion 54 of the actuator 50 presses the hold portion 61 and elastically deforms it slightly upward.

The hold portion 61 of the lock member 60 extends forward approximately horizontally from the front end portion of the second connection portion 66. Only a lower end portion of the lock portion 64 located at the front end of the hold portion 61 is positioned inside the insertion portion 23 of the insulator 20, and the other portions of the lock portion 64 are moved from the insertion portion 23 into the attachment slit 27. Approximately the entire part of the contact surface 64a of the lock portion 64 is positioned inside the attachment slit 27 of the insulator 20. Approximately the entire part of the restriction surface 64b of the lock portion 64 is positioned inside the attachment slit 27 of the insulator 20. The distal end of the hold portion 61 of the lock member 60 slightly protrudes upward from the ceiling wall 21a of the insulator 20.

The second support receiving portion 65 of the lock member 60 is moved away from the upper surface of the bottom wall 21b of the insulator 20. The lock member 60 is supported from below by the pressing force from below exerted on the press receiving portion 67 from the operation portion 55 with the press portion 54 interposed therebetween, instead of the support from below by the bottom wall 21b of the insulator 20. The curved portion of the second connection portion 66 of the lock member 60 is located rearward of the bottom wall 21b of the insulator 20, does not overlap the insulator 20, and is exposed on the lower side through the insulator 20. The lower end portion of the second connection portion 66 of the lock member 60 is still located below the upper surface of the bottom wall 21b.

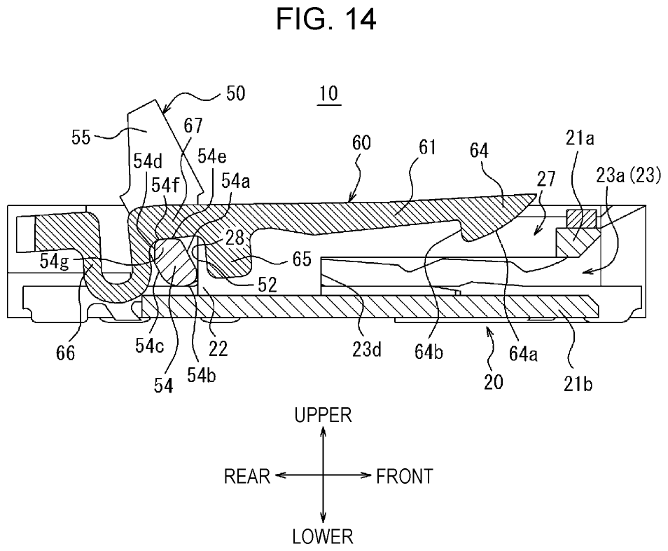

FIG. 14 is a cross-sectional view corresponding to FIG. 12 with the actuator 50 at the open position.

The functions of the actuator 50 and the lock member 60 in the state in which the lock members 60 are attached to the circuit board CB with the lock members 60 attached to the attachment slits 27 of the insulator 20, and when the actuator 50 is at the open position as illustrated in FIG. 14 will be mainly described. The actuator 50 is further turned from the half-open position to the pull-out side, for example, when the operation portion 55 receives an operation of further lifting the operation portion 55 to the pull-out side from an assembly device or an assembly operator. Because the restriction receiving surface 52 comes into contact with the restriction surface 28 located at the rear wall 22 of the insulator 20, the actuator 50 is not allowed to further turn from the open position to the pull-out side.

The press portion 54 of the actuator 50 is greatly tilted at a second angle along with the further turning operation of the actuator 50 in the state in which the press portion 54 of the actuator 50 is stored in the space formed by the second support receiving portion 65, the press receiving portion 67, and the front portion of the second connection portion 66 of the lock member 60. The second angle is larger than the first angle at the half-open position. In this state, the first surface 54a of the press portion 54 is greatly inclined obliquely downward from rear toward front and faces the second support receiving portion 65 of the lock member 60 with a gap in between. The second surface 54b of the press portion 54 faces the upper surface of the bottom wall 21b of the insulator 20 with a gap in between. The third surface 54c of the press portion 54 is greatly inclined obliquely upward from front toward rear and faces the forefront surface of the second connection portion 66 of the lock member 60 with a gap in between. The distal end of the pressure contact portion 54g of the press portion 54 composed of the fourth surface 54d, the rounded surface 54f, and the fifth surface 54e and having a rounded shape is in contact with the lower surface of the press receiving portion 67 of the lock member 60.

The press receiving portion 67 of the lock member 60 receives a pressing force from the press portion 54 at the open position of the actuator 50. The hold portion 61, receiving the pressing force from the pressure contact portion 54g due to the contact between the lower surface of the press receiving portion 67 and the pressure contact portion 54g, is elastically deformed greatly upward. At the open position, the press portion 54 of the actuator 50 presses the hold portion 61 and elastically deforms it greatly upward.

The hold portion 61 of the lock member 60 extends forward and obliquely upward from the front end portion of the second connection portion 66. The lock portion 64 located at the front end of the hold portion 61 is moved from the insertion portion 23 into the attachment slit 27 completely. Part of the lock portion 64 passes through the inside of the attachment slit 27 and is moved through an upper portion of the attachment slit 27 to the outside of the insulator 20. The part of the lock portion 64 is positioned above the insulator 20. An upper end portion of the contact surface 64a of the lock portion 64 is moved upward through the attachment slit 27 of the insulator 20. The restriction surface 64b of the lock portion 64 is positioned inside the attachment slit 27 of the insulator 20. As described above, the distal end of the hold portion 61 of the lock member 60 protrudes greatly upward from the ceiling wall 21a of the insulator 20.

The second support receiving portion 65 of the lock member 60 is moved greatly away from the upper surface of the bottom wall 21b of the insulator 20. The lock member 60 is supported from below by the pressing force from below exerted on the press receiving portion 67 from the operation portion 55 with the press portion 54 interposed therebetween, instead of the support from below by the bottom wall 21b of the insulator 20. The curved portion of the second connection portion 66 of the lock member 60 is located rearward of the bottom wall 21b of the insulator 20, does not overlap the insulator 20, and is exposed on the lower side through the insulator 20. The lower end portion of the second connection portion 66 of the lock member 60 is still located below the upper surface of the bottom wall 21b.

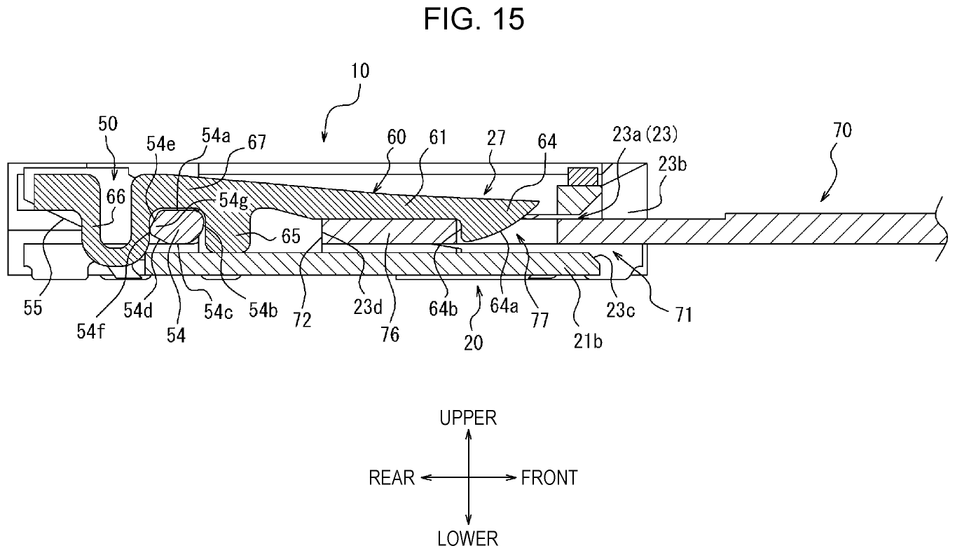

FIG. 15 is a cross-sectional view corresponding to FIG. 12 with the connection object 70 illustrated.

The connection object 70 is inserted into the insertion portion 23 of the insulator 20 with the actuator 50 at the closed position. When the connection object 70 is inserted into the insertion portion 23 of the connector 10, the distal end portion 71 of the connection object 70 is guided by the first inclined surfaces 23b and the second inclined surfaces 23c of the insulator 20 and enters the insertion portion 23. In this operation, even if the position of the connection object 70 being inserted is slightly shifted from the insertion portion 23 in the right-left direction, the introduction portion 78 of the connection object 70 will slide on the first inclined surface 23b of the insulator 20, and the connection object 70 is guided into the insertion portion 23. Similarly, even if the position of the connection object 70 being inserted is slightly shifted from the insertion portion 23 in the up-down direction, the distal end portions 71 of the connection object 70 will slide on the second inclined surfaces 23c of the insulator 20, and the connection object 70 is guided into the insertion portion 23.

When the connection object 70 further moves into the insertion portion 23, the hold portion 76 of the connection object 70 comes into contact with the lock portion 64 of the lock member 60. In this state, The contact between the lock portion 64 and the distal end portion 71 of the connection object 70 with the contact surface 64a of the lock portion 64 on the pull-out side interposed therebetween generates the resistance force that elastically deforms the lock member 60 upward. Thus, the hold portion 61 of the lock member 60 is elastically deformed slightly upward by the resistance force.

When the connection object 70 moves further into the insertion portion 23 with the lock portion 64 in contact with the hold portion 76, the lock portion 64 moves up onto the upper surface of the hold portion 76 while pressing the hold portion 76 from above due to the restoring force against the elastic deformation of the hold portion 61 of the lock member 60. Along with the rearward movement of the connection object 70, the hold portion 76 slides relative to the lower end portion of the lock portion 64.

As illustrated in FIG. 15, in the inserted state, the hold portion 76 of the connection object 70 has passed by the lock portion 64 of the lock member 60 and is stored inside the insertion portion 23. For example, the distal end surface 72 of the connection object 70 comes into contact with the inner surface 23d of the insertion portion 23 of the insulator 20. In this state, the lock portion 64 is no longer in contact with the hold portion 76 in the up-down direction, and the hold portion 61 of the lock member 60 automatically moves back to the position before the connection object 70 is inserted due to the restoring force of the lock member 60.

At the closed position of the actuator 50 as described above, the lock portion 64 is engaged with the lock receiving portion 77 of the connection object 70. The restriction surface 64b of the lock portion 64 faces the hold portion 76 of the connection object 70 from the front side. The restriction surface 64b of the lock portion 64 is close to the front surface of the hold portion 76 and faces the front surface from the front. With this configuration, the lock member 60 holds the connection object 70 inserted into the insertion portion 23 so that the connection object 70 will not come out. In this state, even if the connection object 70 is forcibly pulled, the hold portion 76 of the connection object 70 will come into contact with the lock portion 64. Thus, the connection object 70 is effectively held so as not to come out.

As described above, the connector 10 does not require an operation of the operation portion 55 of the actuator 50 by an assembly device or an assembly operator, and only a single action of inserting the connection object 70 enables the connection object 70 to be held in the inserted state and not to come out. During the work of inserting the connection object 70 into the connector 10, only the lock members 60 are elastically deformed. The actuator 50 is always at the closed position and does not turn to the pull-out side.

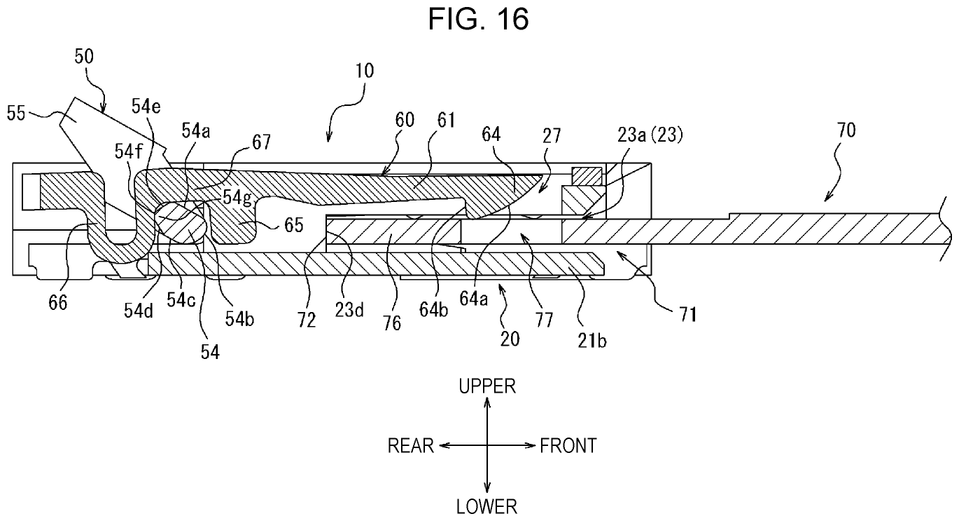

FIG. 16 is a cross-sectional view corresponding to FIG. 13 with the connection object 70 illustrated.

To pull out the connection object 70 from the connector 10, an assembly device or an assembly operator operates the operation portion 55 of the actuator 50 to turn the actuator 50 to the pull-out side. The operation portion 55 receives an operation of opening the actuator 50 from the closed position to the pull-out side. When the actuator 50 turns to a half-open position, the hold portion 61 of the lock member 60 is elastically deformed slightly upward. In this state, the lock portion 64 moves to immediately above the lock receiving portion 77 of the connection object 70. The restriction surface 64b of the lock portion 64 is positioned above the front surface of the hold portion 76 and no longer faces the front surface.

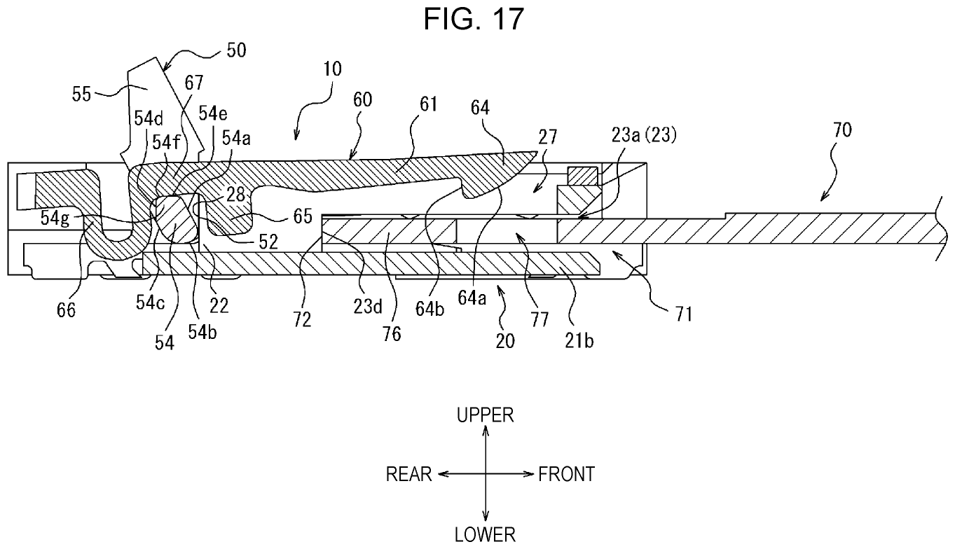

FIG. 17 is a cross-sectional view corresponding to FIG. 14 with the connection object 70 illustrated.

When the operation portion 55 receives an operation of opening the actuator 50 from the closed position to the open position, and the actuator 50 turns to the open position, the hold portion 61 of the lock member 60 is elastically deformed greatly upward. In this state, the lock portion 64 is greatly away upward from the lock receiving portion 77 of the connection object 70. The restriction surface 64b of the lock portion 64 is also greatly away upward from the front surface of the hold portion 76 and no longer faces the front surface at all.

Thus, the lock portion 64 of the lock member 60 and the lock receiving portion 77 of the connection object 70 are no longer engaged with each other. The locking between the lock portion 64 and the lock receiving portion 77 is released. Thus, the connection object 70 can be pulled out from the connector 10.

The following describes advantageous effects of the connector 10 with attention focused mainly on the connector 10, and the same or similar description can be applied to an electronic device including the connector 10.

In an embodiment described above, the connector 10 can maintain the reliability even if it is downsized. In the connector 10, the hold portion 61 including the lock portion 64 and the first support receiving portion 63 including the attachment portion 68 are different extension portions, and the first support receiving portion 63 is not located on the same straight line as the hold portion 61. This enables the distance from the lock portion 64 to the attachment portion 68 to be longer in the connector 10 than in a conventional connector including a lock portion and a mount portion formed in a single extension portion. In the connector 10, the distance between the lock portion 64 and the attachment portion 68 can be long without increasing the dimension of the connector 10 in the insertion-pull-out direction of the connection object 70.

With this configuration, even when the connector 10 is downsized, the movable range for the lock member 60 to be elastically deformed can be kept long. This makes it easy for the lock member 60 to be elastically deformed. Thus, the load exerted on the foregoing movable range can be low when the operation portion 55 of the actuator 50 is operated, and the lock member 60 is elastically deformed. This reduces the possibility that the lock member 60 may be plastically deformed.

In addition, since the distance between the attachment portion 68 mounted on the circuit board CB and the lock portion 64 is long, the stress exerted on the attachment portion 68 along with the elastic deformation of the foregoing movable range is low. This makes problems such as solder separation at the attachment portion 68 less likely.

This makes it possible to maintain the reliability of the connector 10 as a product. The connector 10 makes it possible to achieve both downsizing and reliability.

Since the first support receiving portion 63 extends in the insertion-pull-out direction of the connection object 70, the first connection portion 62 connecting the hold portion 61 and the first support receiving portion 63 to each other extends from the hold portion 61 and is bent at 180 degrees. This makes it possible to further increase the distance between the lock portion 64 and the attachment portion 68. Thus, the foregoing effects related to achieving both downsizing and reliability are more significant in the connector 10.

Since the first connection portion 62 is curved in a U-shape curved line, the hold portion 61 and the first support receiving portion 63 can be connected to each other more smoothly in the connector 10. With this, the stress exerted on the first connection portion 62 when the lock member 60 is elastically deformed is more likely to be distributed than, for example, in a configuration in which the first connection portion 62 has a shape of being bent twice at a right angle. Thus, the breakage of the lock member 60 in the first connection portion 62 is less likely in the connector 10, and the effects related to reliability are more significant.

Since the thickness direction of the hold portion 61 of the lock member 60 is the same as the arrangement direction of the multiple contacts 30, the dimension of the connector 10 in the arrangement direction can be small. In addition, the strength of the first connection portion 62 connecting the hold portion 61 and the first support receiving portion 63 to each other is increased, which reduces the breakage of the lock member 60 when the lock member 60 is elastically deformed. Thus, the effects related to achieving both downsizing and reliability are more significant in the connector 10.

Since the lock member 60 includes the second connection portion 66 formed in the hold portion 61 and extending toward the circuit board CB in the direction orthogonal to the insertion-pull-out direction and the arrangement direction of the multiple contacts 30, the distance between the lock portion 64 and the attachment portion 68 can be longer in the connector 10 without increasing the dimension of the connector 10 in the insertion-pull-out direction of the connection object 70. Thus, the aforementioned effects related to achieving both downsizing and reliability are more significant in the connector 10.

Since the second connection portion 66 is curved in a U-shape curved line, the portion of the hold portion 61 located frontward of the second connection portion 66 and the first connection portion 62 can be connected to each other more smoothly in the connector 10. With this, the stress exerted on the second connection portion 66 when the lock member 60 is elastically deformed is more likely to be distributed than, for example, in a configuration in which the second connection portion 66 has a shape of being bent twice at a right angle. Thus, the breakage of the lock member 60 in the second connection portion 66 is less likely in the connector 10, and the effects related to reliability is more significant.

Since the distal end of the curved portion in the second connection portion 66 is located outward of the inner surface of the insertion portion 23, the second connection portion 66 can be long without increasing the dimension of the connector 10 in the direction orthogonal to the insertion-pull-out direction of the connection object 70 and the arrangement direction of the multiple contacts 30. Thus, the effects related to achieving both downsizing and reliability are more significant in the connector 10.

In the connector 10, since the hold portion 61 is between parts of the insulator 20 in the arrangement direction of the multiple contacts 30, the sway in the arrangement direction of the multiple contacts 30 of the lock portion 64 located at the distal end of the hold portion 61 can be reduced. Thus, the reliability of the lock portion 64 locking the connection object 70 is high in the connector 10.

Since the connector 10 includes the press portions 54 that press and elastically deform the hold portions 61 at the open position of the actuator 50, the lock portions 64 of the lock members 60 can be moved by the press portions 54. Hence, although the lock portions 64 can lock the connection object 70 firmly in the connector 10, the operation received by the operation portion 55 of the actuator 50 easily enables pulling out of the connection object 70.

In the connector 10, since the attachment portion 68 is formed at the same position as the press receiving portion 67 in the insertion-pull-out direction of the connection object 70, the lock portion 64 located at the distal end of the hold portion 61 can be moved upward more precisely. In the connector 10 described above, the lock portion 64 can be moved upward more precisely according to the pressing force exerted on the press receiving portion 67 with the attachment portion 68 as a fulcrum.

In the connector, since the attachment portions 68 of the connector 10 are mounted onto the circuit board CB, the lock members 60 can be attached to the circuit board CB more firmly. This enables the lock portions 64 to move upward more precisely according to the pressing force exerted on the press receiving portions 67 with the attachment portions 68 as fulcrums in the connector 10. In addition, the breakage of the attachment portions 68 as the mount portions can be reduced in the connector 10. This makes it possible to maintain the reliability of the connector 10 as a product.

Since the attachment portion 68 has a two-leg shape in the connector 10, for example, part of the insulator 20 may be formed in the space between the two legs of the attachment portion 68, and the attachment portion 68 may be engaged with the formed part of the insulator 20.

In the connector 10, since the press portion 54 of the actuator 50 is stored in the space formed by the second support receiving portion 65, the press receiving portion 67, and the front portion of the second connection portion 66 of the lock member 60, the movement of the lock member 60 in the front-rear direction can be restricted. Hence, in the connector 10, unintended deformation of the lock member 60 along with the movement in the front-rear direction, different from the elastic deformation of the hold portion 61 of the lock member 60, can be reduced.

In the connector 10, since the ceiling portion 43 of the metal member 40 is in contact with or close to the upper surface of the wall portion 26a of the metal-member attachment slit 26 and faces it from above, even if the height of the connector 10 is reduced, the breakage of the insulator 20 due to an upward force exerted on the connection object 70 can be reduced. More specifically, even if the height of the connector 10 is reduced, the breakage of the ceiling wall 21a of the insulator 20 due to such force can be reduced. Hence, the robustness of the connector 10 is higher than in a configuration without the metal members 40.

In the connector 10, since the wall portion 26a is interposed between the ceiling portion 43 and the insertion portion 23, the contact between the connection object 70 being inserted into the insertion portion 23 and the metal members 40 can be reduced. Thus, in the connector 10, problems such as abrasion or the like of the connection object 70 due to contact with the metal member 40 can be reduced.

Since the metal member 40 is located outward of the outermost first contact 30a in the arrangement direction of the multiple contacts 30, the position of the first-contact attachment slit 24 and the position of the metal-member attachment slit 26 differ in the right-left direction in the insulator 20. Hence, the situation in which the thickness of the insulator 20 in the portion where the first contact 30a is attached is too thin can be avoided. Thus, degradation of the strength of the insulator 20 can be reduced in the connector 10.

Since the mount portions 42 of the metal members 40 are mounted onto the circuit board CB, the metal members 40 are attached to the circuit board CB more firmly. Hence, in the connector 10, breakage of the insulator 20 and the metal members 40 due to an upward force exerted on the connection object 70 can be reduced.

Since the second surface S2 is lower than the first surface S1 in the wall portion 26a, the thickness in the up-down direction of the wall portion 26a where the second surface S2 is located is large. Hence, the strength of the insulator 20 in the end portions in the arrangement direction of the multiple contacts 30 can be high in the connector 10. Hence, in the connector 10, breakage of the insulator 20 and the metal members 40 due to an upward force exerted on the connection object 70 can be reduced.

In the connector 10, since the third surface S3 of the wall portion 26a is an inclined surface inclined rearward and connected to the first surface S1 and the second surface S2, even if the height of the connector 10 is reduced, the operability related to the insertion of the connection object 70 can be high. Hence, also as for the connector 10 the height of which is reduced, insertion of the connection object 70 will be easy.

Since the metal members 40 are located at the same position as the lock members 60 in the arrangement direction of the multiple contacts 30, the connector 10 can be downsized in the arrangement direction of the multiple contacts 30. Hence, the connector 10 enables the space on the mounting surface of the circuit board CB to be used effectively.

Those skilled in the art will clearly understand that the present disclosure can be implemented in other appropriate embodiments other than the aforementioned embodiment without departing from the spirit or the essential features. Hence, the above description is exemplary, and the present disclosure is not limited to the above description. The scope of the disclosure is defined not by the above description but by the appended claims. Of various changes, several changes within the scope of the equivalents of the claims are included in the scope of the disclosure.

For example, the shape, position, orientation, of each aforementioned component, the number of components, and the like are not limited to the above description and the illustration of the drawings. The shape, position, orientation of each component, the number of components, and the like may be configured in any way that enables the function of the component.

The aforementioned method of assembling the connector 10 is not limited to the above description. The connector 10 may be assembled by any method that enables each component to function properly. For example, at least one item out of the first contacts 30a, the second contacts 30b, the metal members 40, and the lock members 60 may be integrated into the insulator 20 by insert molding.

Although in the description of the aforementioned embodiment, the first support receiving portion 63 extends in the insertion-pull-out direction of the connection object 70, the present disclosure is not limited to this configuration. The first support receiving portion 63 may extend in any direction unless the first support receiving portion 63 is not located in the same straight line as the hold portion 61. For example, the first connection portion 62 may be bent at only 90 degrees instead of 180 degrees, and the first support receiving portion 63 connected to the first connection portion 62 may extend in the arrangement direction of the multiple contacts 30.

Although in the description of the aforementioned embodiment, the first connection portion 62 is curved in a U shape, the present disclosure is not limited to this configuration. The first connection portion 62 may have any shape that connects the hold portion 61 and the first support receiving portion 63 to each other. For example, the first connection portion 62 may be bent twice at a right angle to achieve a 180-degree bent as a whole or may be bent in a V shape.

Although in the description of the aforementioned embodiment, the thickness direction of the hold portion 61 of the lock member 60 is the same as the arrangement direction of the multiple contacts 30, the present disclosure is not limited to this configuration. The thickness direction of the hold portion 61 of the lock member 60 may differ from the arrangement direction of the multiple contacts 30. For example, the thickness direction of the entire lock member 60 may be the same as the up-down direction.

Although in the description of the aforementioned embodiment, the lock member 60 includes the second connection portion 66, the present disclosure is not limited to this configuration. The lock member 60 may have a configuration in which the hold portion 61 does not include the second connection portion 66 and extends linearly.

Although in the description of the aforementioned embodiment, the second connection portion 66 of the lock member 60 extends toward the circuit board CB in the up-down direction, the present disclosure is not limited to this configuration. The second connection portion 66, for example, may extend upward from a portion of the hold portion 61 located further on the circuit board CB side in the attachment slit 27.

Although in the description of the aforementioned embodiment, the second connection portion 66 is curved in a U shape, the present disclosure is not limited to this configuration. The second connection portion 66 may have any shape that connects the portion of the hold portion 61 located frontward of the second connection portion 66 and the first connection portion 62. For example, the second connection portion 66 may be bent twice at a right angle to achieve a 180-degree bent as a whole or may be bent in a V shape.

Although in the description of the aforementioned embodiment, the hold portion 61 is between parts of the insulator 20 in the arrangement direction of the multiple contacts 30, the present disclosure is not limited to this configuration. A configuration in which the hold portion 61 is not between parts of the insulator 20 in the arrangement direction of the multiple contacts 30 is possible.

Although in the description of the aforementioned embodiment, the connector 10 includes the actuator 50, the present disclosure is not limited to this configuration. The connector 10 may have a configuration without an actuator 50.

Although in the description of the aforementioned embodiment, the insertion force to oppose to the lock portions 64 of the lock members 60 is necessary when the connection object 70 is inserted into the insertion portion 23, the present disclosure is not limited to this configuration. The connector 10 may have a so-called zero insertion force (ZIF) structure in which when the connection object 70 is inserted into the insertion portion 23, the connection object 70 does not make contact with the lock members 60 and can be inserted with an insertion force close to zero.

Although in the description of the aforementioned embodiment, the attachment portion 68 is formed at the same position as the press receiving portion 67 in the insertion-pull-out direction of the connection object 70, the present disclosure is not limited to this configuration. The attachment portion 68 may be formed at any position in the lock member 60 that enables the aforementioned operation of the lock portion 64.

Although in the description of the aforementioned embodiment, the attachment portions 68 are mounted onto the circuit board CB, the present disclosure is not limited to this configuration. The attachment portions 68 may be attached to the insulator 20. For example, the attachment portions 68 may be attached to the insulator 20 by press-fitting or insert molding.

Although in the aforementioned embodiment, the first support receiving portion 63 is located outward of the hold portion 61 in the right-left direction in the lock member 60, the present disclosure is not limited to this configuration. In the lock member 60, the hold portion 61 may be located outward of the first support receiving portion 63 in the right-left direction.

Although in the aforementioned embodiment, only the hold portion 61 is elastically deformable in the lock member 60, the present disclosure is not limited to this configuration. In addition to the hold portion 61, the first connection portion 62 may also be elastically deformable.

Although in the aforementioned embodiment, the insulator 20 is not present immediately in front of the second support receiving portion 65 of the lock member 60, the present disclosure is not limited to this configuration. For example, the insulator 20 may have a protruding wall protruding upward from the bottom wall 21b, and the second support receiving portion 65 of the lock member 60 may be in contact with or close to the protruding wall and face it from the rear side. This configuration enables the movement of the lock member 60 in the front-rear direction to be further restricted in the connector 10. Hence, in the connector 10, unintended deformation of the lock member 60 along with the movement in the front-rear direction, different from elastic deformation of the hold portion 61 of the lock member 60, can be further reduced.

Although in the aforementioned embodiment, only the bottom wall 21b of the insulator 20 is present under the lock portions 64 of the lock members 60, the present disclosure is not limited to this configuration. Protrusions protruding upward from the bottom wall 21b of the insulator 20 may be formed under the lock portions 64. This configuration improves the force of the connector 10 for holding the connection object 70.

Although in the description of the aforementioned embodiment, the pressure contact portion 54g of the press portion 54 has a rounded shape, the present disclosure is not limited to this configuration. The pressure contact portion 54g may have any shape. For example, the pressure contact portion 54g may have a configuration without the rounded surface 54f, and the fourth surface 54d and the fifth surface 54e may be directly connected to each other to form an acute angle.

Although in the description of the aforementioned embodiment, the insertion portion 23 includes the inner surface 23d which serves as a reference for positioning the distal end surface 72 of the connection object 70 in the inserted state in the insertion direction, the present disclosure is not limited to this configuration. A configuration in which the insertion portion 23 does not include the inner surface 23d mentioned above is possible. In this case, for example, the insulator 20 may include a certain structure for positioning both right and left end portions of the connection object 70 in the insertion direction.

Although in the description of the aforementioned embodiment, the connector 10 can lock the connection object 70 by only a single action of inserting the connection object 70, the present disclosure is not limited to this configuration. The connector 10 may have a configuration that requires a certain direct operation of the actuator 50 by an assembly device or an assembly operator.

The connector 10 described above is mounted on electronic devices. Examples of the electronic devices include communication devices such as smartphones. However, the present disclosure is not limited to these. Examples of the electronic devices may include any kind of information devices such as personal computers, copy machines, printers, fax machines, and multifunction printers. Examples of the electronic devices may include any kind of car-mounted devices such as cameras, radars, drive recorders, and engine control units. Examples of the electronic devices may include any kind of car-mounted devices used in car-mounted systems, such as car navigation systems, advanced driver assistance systems, and security systems. In addition, examples of the electronic devices may include any kind of industrial devices. Examples of the electronic devices may include any kind of audio video devices such as liquid crystal television sets, recorders, cameras, and headphones.

In such electronic devices, the aforementioned effect of the connector 10 that the connector 10 can maintain the reliability even if it is downsized improves the reliability of the electronic devices as products. In addition, the effect makes it easy to downsize the electronic devices.

The following concepts can be extracted from the present disclosure.

(1)

A connector that a connection object is inserted into and pulled out from, including:
an insulator including an insertion portion into which the connection object is inserted;
multiple contacts attached to the insulator; and
a lock member attached to the insulator, in which
the lock member includes:
   an elastically deformable hold portion extending in an insertion-pull-out direction of the connection object;
   a support receiving portion adjoining the hold portion in a direction different from the insertion-pull-out direction;
   an elastically deformable first connection portion located on an insertion side on which the connection object is inserted relative to the hold portion and the support receiving portion and connecting the hold portion and the support receiving portion;
   a lock portion located in the hold portion and configured to be engaged with a lock receiving portion of the connection object in an inserted state in which the connection object is inserted into the insertion portion; and
   an attachment portion located in the support receiving portion and configured to be attached to the insulator or a circuit board.
      (2)

The connector according to (1), in which
the support receiving portion extends in the insertion-pull-out direction.
   (3)

The connector according to (1) or (2), in which
a thickness direction of the hold portion of the lock member is a same as an arrangement direction of the multiple contacts.
   (4)

The connector according to any one of (1) to (3), in which
the lock member includes a second connection portion located in the hold portion and extending toward the circuit board in a direction orthogonal to the insertion-pull-out direction and an arrangement direction of the multiple contacts.
   (5)

The connector according to any one of (1) to (4), in which
the insulator is interposed between the lock portion and the circuit board.
   (6)

The connector according to (4), in which
a distal end of a curved portion in the second connection portion is located outward of an inner surface of the insertion portion.
   (7)

The connector according to any one of (1) to (6), in which
the hold portion is between parts of the insulator in an arrangement direction of the multiple contacts.
   (8)

The connector according to any one of (1) to (7), further including
an actuator configured to be turned relative to the insulator between a closed position at which the actuator is closed relative to the insulator and an open position at which the actuator is open relative to the insulator, in which
the actuator includes a press portion configured to press and elastically deforms the hold portion at the open position, and
the lock member includes a press receiving portion located in the hold portion and configured to receive a pressing force from the press portion at the open position.
   (9)

The connector according to (8), in which
the attachment portion is at a same position as the press receiving portion in the insertion-pull-out direction.
   (10)

The connector according to any one of (1) to (9), in which
the attachment portion is configured to be mounted on the circuit board.
   (11) The connector according to any one of (1) to (10), in which
a surface of the lock member is plated, and plating of the attachment portion has a higher wettability than portions of the lock member other than the attachment portion.
   (12)

An electronic device including
the connector according to any one of (1) to (11).

### REFERENCE SIGNS

10 connector
20 insulator
21 outer peripheral wall
21a ceiling wall
21b bottom wall
21c side wall
22 rear wall
23 insertion portion
23a insertion opening
23b first inclined surface
23c second inclined surface
23d inner surface
24 first-contact attachment slit
25 second-contact attachment slit
26 metal-member attachment slit
26a wall portion
27 attachment slit
28 restriction surface
30 contact
30a first contact
31a engagement portion
32a mount portion
33a connection portion
34a elastic contact portion
30b second contact
31b engagement portion
32b mount portion
33b elastic contact portion
40 metal member
41 base portion
42 mount portion
43 ceiling portion
50 actuator
51 base portion
52 restriction receiving surface
53 cam portion
54 press portion
54a first surface
54b second surface
54c third surface
54d fourth surface
54e fifth surface
54f rounded surface
54g pressure contact portion
55 operation portion
60 lock member
61 hold portion
62 first connection portion
63 first support receiving portion (support receiving portion)
64 lock portion
64a contact surface
64b restriction surface
65 second support receiving portion
66 second connection portion
67 press receiving portion
68 attachment portion
70 connection object
71 distal end portion
72 distal end surface
73 signal line
73a first signal line
73b second signal line
74 ground portion
75 outer cover
76 hold portion
77 lock receiving portion
78 introduction portion
CB circuit board
S1 first surface
S2 second surface
S3 third surface

1. A connector that a connection object is inserted into and pulled out from, comprising:
an insulator comprising an insertion portion into which the connection object is inserted;
multiple contacts attached to the insulator; and
a lock member attached to the insulator, wherein
the lock member comprises:
an elastically deformable hold portion extending in an insertion-pull-out direction of the connection object;
a support receiving portion adjoining the hold portion in a direction different from the insertion-pull-out direction;
an elastically deformable first connection portion located on an insertion side on which the connection object is inserted relative to the hold portion and the support receiving portion and connecting the hold portion and the support receiving portion;
a lock portion located in the hold portion and configured to be engaged with a lock receiving portion of the connection object in an inserted state in which the connection object is inserted into the insertion portion; and
an attachment portion located in the support receiving portion and configured to be attached to the insulator or a circuit board.

2. The connector according to claim 1, wherein the support receiving portion extends in the insertion-pull-out direction.

3. The connector according to claim 1, wherein
a thickness direction of the hold portion of the lock member is a same as an arrangement direction of the multiple contacts.

4. The connector according to claim 1, wherein
the lock member includes a second connection portion located in the hold portion and extending toward the circuit board in a direction orthogonal to the insertion-pull-out direction and an arrangement direction of the multiple contacts.

5. The connector according to claim 1, wherein
the insulator is interposed between the lock portion and the circuit board.

6. The connector according to claim 4, wherein
a distal end of a curved portion in the second connection portion is located outward of an inner surface of the insertion portion.

7. The connector according to claim 1, wherein
the hold portion is between parts of the insulator in an arrangement direction of the multiple contacts.

8. The connector according to claim 1, further comprising
an actuator configured to be turned relative to the insulator between a closed position at which the actuator is closed relative to the insulator and an open position at which the actuator is open relative to the insulator, wherein
the actuator comprises a press portion configured to press and elastically deforms the hold portion at the open position, and
the lock member comprises a press receiving portion located in the hold portion and configured to receive a pressing force from the press portion at the open position.

9. The connector according to claim 8, wherein
the attachment portion is at a same position as the press receiving portion in the insertion-pull-out direction.

10. The connector according to claim 1, wherein
the attachment portion is configured to be mounted on the circuit board.

11. The connector according to claim 1, wherein
a surface of the lock member is plated, and plating of the attachment portion has a higher wettability than portions of the lock member other than the attachment portion.

12. An electronic device comprising
the connector according to claim 1.
